(19) United States
(12) Patent Application Publication
(10) Pub. No.: US 2015/0043854 A1
(43) Pub. Date: Feb. 12, 2015

(54) Method and Component

(71) Applicants: Patrik Dahlman, Shanghai (CN); Viktor Recina, Torslanda (SE)

(72) Inventors: Patrik Dahlman, Shanghai (CN); Viktor Recina, Torslanda (SE)

(21) Appl. No.: 14/367,881

(22) PCT Filed: Nov. 26, 2012
(86) PCT No.: PCT/SE2012/000194

§ 371 Date: Jun. 20, 2014

(30) Foreign Application Priority Data
Dec. 20, 2011 (SE) 1100939-6

(51) Int. Cl. B23K 11/34; F16C 33/60; B23K 11/04; F16C 33/64; B21D 53/10

(52) U.S. Cl. CPC B23K 11/34; F16C 33/64; B21D 53/10; B23K 11/04; F16C 33/60
USPC 384/499; 219/100; 219/78.13; 384/569

(57) ABSTRACT

A method for manufacturing a steel component having a flash butt weld joint, which comprises the step of flash butt welding the joint. The method comprises the step of heating at least part of the component to a temperature above the martensite start temperature before and/or during said flash butt welding step.

### CROSS REFERENCE TO RELATED APPLICATIONS

This is a National Stage application claiming the benefit of International Application Number PCT/SE2012/000194 filed on 26 Nov. 2012 (26 Nov. 2012), which claims the benefit of Sweden Patent Application Number SE20110000939 filed on 20 Dec. 2011 (20 Dec. 2011), both of which are incorporated herein by reference in their entireties.

### TECHNICAL FIELD

The present invention concerns a method for manufacturing a component, such as a bearing ring, from steel. The present invention also concerns a component manufactured using such a method.

### BACKGROUND OF THE INVENTION

Flash-butt welding, or “flash welding” is a resistance welding technique for joining segments of metal rail, rod, chain or pipe in which the segments are aligned end to end and electronically charged, producing an electric arc that melts and welds the ends of the segments, yielding an exceptionally strong and smooth joint.

A flash butt welding circuit usually consists of a low-voltage, high-current energy source (usually a welding transformer) and two clamping electrodes. The two segments that are to be welded are clamped in the electrodes and brought together until they meet, making light contact. Energizing the transformer causes a high-density current to flow through the areas that are in contact with each other. Flashing starts, and the segments are forged together with sufficient force and speed to maintain a flashing action. After a heat gradient has been established on the two surfaces to be welded, an upset force is suddenly applied to complete the weld. This upset force extrudes slag, oxides and molten metal from the weld zone, leaving a welding accretion in the colder zone of the heated metal. The joint is then allowed to cool slightly before the clamps are opened to release the welded article. The welding accretion may be left in place or removed by shearing while the welded article is still hot, or by grinding, depending on the requirements.

Although flash butt welding is a simple and efficient welding technique, the physical properties of a component in the vicinity of its weld joint(s) may be adversely affected by the flash butt welding, because of defects, such as cracks associated with the formation of martensite, which is brittle, which occur during and after the flash butt welding.

### SUMMARY OF THE INVENTION

An object of the invention is to provide an improved method for manufacturing a steel component having a flash butt weld joint.

This object is achieved by a method comprising the step of flash butt welding the joint and heating at least part of the component to a temperature above the martensite start temperature (Ms) before and/or during said flash butt welding step. Martensite formation during and after the flash butt welding step will thereby be avoided or reduced, and the component will consequently be much less susceptible to crack formation. The formation of hard brittle martensite is namely accompanied by mechanical effects, such as shrinkage stresses and thermal stresses, which cause an increase in the level of internal stresses in the component, and consequently increase the risk of brittle fracture or cracking.

Martensite is formed by rapid cooling (quenching) of austenite which traps carbon atoms that do not have time to diffuse out of the steel's crystal structure and makes the structure more brittle. This martensitic reaction begins during cooling when the austenite reaches the martensite start temperature (Ms) and the parent austenite becomes mechanically unstable. At a constant temperature below Ms, a fraction of the parent austenite transforms rapidly, then no further transformation will occur. When the temperature is decreased, more of the austenite transforms to martensite. Martensite has a lower density than austenite, so that the martensitic transformation results in a relative change of volume. By heating at least part of a component that is to be flash butt welded to a temperature above the martensite start temperature (Ms) before and/or during said flash butt welding step, defects such as weld/quench cracks associated with the formation of martensite during or after flash butt welding may be avoided or reduced.

The expression “heating at least part of the component to a temperature above the martensite start temperature (Ms) during the flash butt welding step” is intended to mean that heat apart from the heat generated by the flash butt welding, is supplied to at least part of the component during the flash butt welding step.

Heat may be supplied only in the vicinity of what will become a weld joint, or to one or more parts of the component, whereupon heat may be transferred by conduction through the component for example.

According to an embodiment of the invention the heat is supplied by heating at least part of the component with heating means, such as induction heating means.

According to a further embodiment of the invention the heat is supplied by heating at least part of the component with the flash butt welding apparatus. The heat is preferably supplied using alternating current (AC) so that the component may be kept cooler than if direct current (DC) were used. In another embodiment, the heat is supplied by direct current (DC) or of a combination of direct current (DC) and alternating current (AC).

According to an embodiment of the invention the heat is additionally or alternatively supplied by insulating at least part of the component before and/or during the flash butt welding step. Thermally insulating material may be provided around at least a part of the component to prevent, or to slow down the rate of cooling of the component. A sleeve of thermally insulating material may for example be placed around at least part of the component before and/or during the flash butt welding step.

According to another embodiment of the invention, the method comprises the step of cooling the component, to room temperature for example, only after the flash butt welding step.

According to another embodiment of the invention, at least part of the the component is heated to a temperature 1° C. to 50° C., 1 to 100 ° C. or 1 to 200 ° C. above the martensite start temperature (Ms) before and/or during the flash butt welding step.

According to a further embodiment of the invention the component is a ring, such as a bearing ring. The method according to the present invention is particularly, but not exclusively, suitable for the manufacture of large sized rings (i.e. rings having an outer diameter equal to or greater than 0.5 m, greater than 1 m, greater than 2 m or greater than 3 m).

According to an embodiment of the invention the method comprises the step of heating at least part of a steel bar to a temperature above the martensite start temperature (Ms) before and/or while the steel bar is bent into a ring or ring segment. The steel bar will thereby be easier to bend into a ring or ring segment.

According to another embodiment of the invention, the steel has a carbon content of 0.1-1.1 weight-%, preferably 0.6-1.1 weight-%, or most preferably 0.8-1.05 weight-%.

According to an embodiment of the invention, the steel has the following composition in weight-%:

C 0.5-1.1

Si 0-0.15

Mn 0-1.0

Cr 0.01-2.0

Mo 0.01-1.0

Ni 0.01-2.0

V and/or Nb 0.01-1.0 of V or 0.01-1.0 of Nb, or 0.01-1.0 of both elements

S 0-0.002

P 0-0.010

Cu 0-0.15

Al 0.010-1.0

balance Fe and normally occurring impurities.

By minimizing the silicon content, and reducing the manganese and chromium content of the steel (which are alloying elements that are easily oxidised) to the levels indicated above, the steel will be more stable and will not be as easily oxidised during flash butt welding. The sulphur content of the steel is reduced to an absolute minimum, whereby the content of non-desirable non-metallic inclusions in steel that has been subjected to flash butt welding will be minimized. A high level of through-thickness ductility may be obtained by means of a special ladle treatment during steelmaking which ensures very low sulphur content and a controlled shape of non-metallic inclusions.

The phosphorus content of the steel is also reduced to an absolute minimum in order to hinder residual or tramp elements in the steel migrating to austenite grain boundaries when the steel is subjected to flash butt welding, which would otherwise significantly weaken the weld zone. The addition of molybdenum, nickel and optionally vanadium provides steel with a hardenability sufficient to enable through-hardening of large components (i.e. component having an outer diameter of 500 mm or more).

The adverse effects of the unfavourable material flow that flash butt welding creates may therefore be limited by using such steel. Using such steel namely provides a joined/welded component having a superior weld joint since the joined/welded component does not contain areas of structural weakness as might otherwise occur. Such a joined/welded component therefore has a high degree of structural integrity compared to joined/welded component that does not comprise such steel. Such steel is therefore suitable for flash butt welding and in particular for the manufacture of components intended for an application with high demands on fatigue and toughness properties, which components are to be subjected to flash butt welding during or after their manufacture.

The present invention also concerns a component that it is manufactured using a method according to any of the embodiments of the invention. The component may be a ring, such as a bearing ring for use in a bearing such as a roller bearing, a needle bearing, a tapered roller bearing, a spherical roller bearing, a toroidal roller bearing, a thrust bearing or a bearing for any application in which is subjected to alternating Hertzian stresses, such as rolling contact or combined rolling and sliding. The bearing may for example be used in automotive, wind, marine, metal producing or other machine applications which require high wear resistance and/or increased fatigue and tensile strength.

### BRIEF DESCRIPTION OF THE DRAWINGS

The present invention will hereinafter be further explained by means of non-limiting examples with reference to the appended schematic figures where;

FIGS. 1-4 show steps of a method according to an embodiment of the invention,

FIG. 5 shows a bearing ring after a flash butt welding step according to an embodiment of the invention,

FIG. 6 shows the steps of a method according to an embodiment of the invention, and

FIG. 7 shows a bearing according to an embodiment of the invention.

It should be noted that the drawings have not been drawn to scale and that the dimensions of certain features have been exaggerated for the sake of clarity.

### DETAILED DESCRIPTION OF EMBODIMENTS

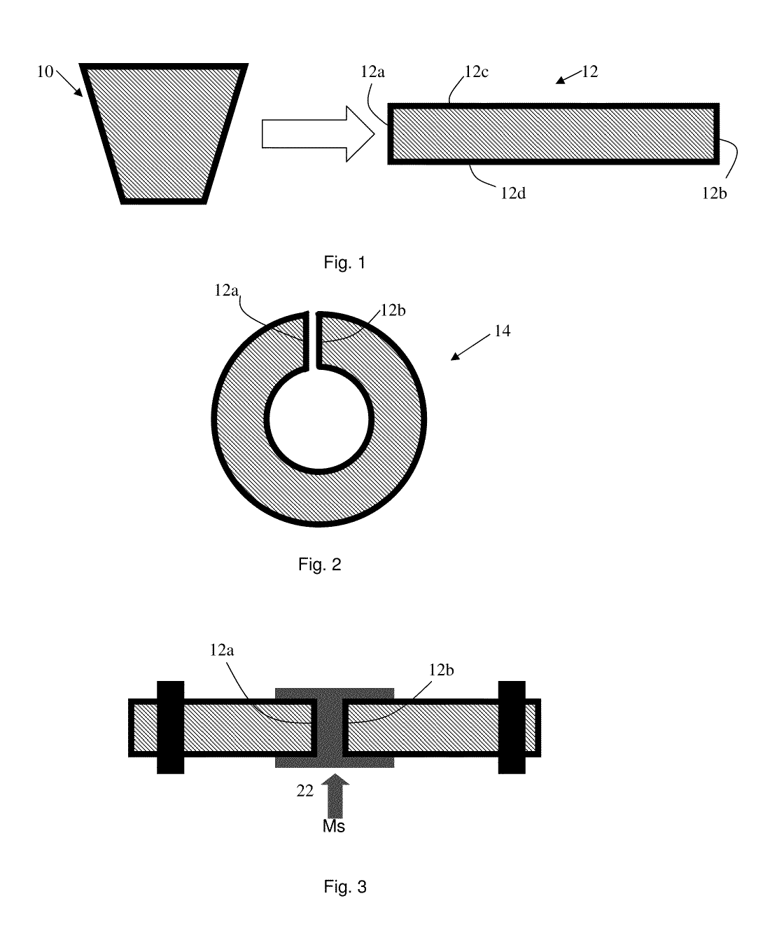

FIGS. 1-4 schematically show various method steps of a method according to an embodiment of the invention. FIG. 1 shows steel 10 that is forged to produce a steel bar 12 having two opposed ends 12a and 12b. A slab, bloom, or billet may be forged from an ingot weighing over 4 ton, over 10 ton, over 15 ton, over 20 ton or more. At least one steel bar may be forged or cut from the slab bloom or billet. A billet is a length of metal that has a round or square cross-section, with an area less than 230 cm2. A bloom is similar to a billet except its cross-sectional area is greater than 230 cm2. A slab is a length of metal that is rectangular in cross-section. The steel may have the following composition in weight-%: C 0.5-1.1, Si 0-0.15, Mn 0-1.0, Cr 0.01-2.0, Mo 0.01-1.0, Ni 0.01-2.0, V and/or Nb; 0.01-1.0 of V or 0.01-1.0 of Nb, or 0.01-1.0 of both elements, S 0-0.002, P 0-0.010, Cu 0-0.15, Al 0.010-1.0 and balance Fe and normally occurring impurities.

It should be noted that the ends 12a, 12b of the steel bar 12 shown in the illustrated embodiment comprise ends that form an angle of 90° to a side surface 12c, 12d of the steel bar 12. A steel bar 12 may however comprise an end 12a, 12b that forms an angle greater or less than 90° to a side surface 12c, 12d of a steel bar, a steel bar 12 may namely comprise diagonally sloping ends. Furthermore, the ends 12a and 12b of the steel bar 12 need not necessarily have a flat surface.

At least one part of at least one surface 12a, 12b, 12c, 12d of the steel bar may be carburized prior to flash butt welding. For example, the opposed ends may be uniformly or non-uniformly carburized to form a continuous or non-continuous carburized layer using any conventional method in which the steel bar is heated in the presence of another material that liberates carbon as it decomposes and then cooled rapidly by quenching.

FIG. 2 shows a single steel bar 12 that has been formed into an open bearing ring 14. It should be noted that each of a plurality of steel bars 12 may alternatively be formed into a ring segment, whereby two or more ring segments may then be flash butt welded together to form a bearing ring 14 comprising two or more weld joints. According to an embodiment of the invention at least part of a steel bar is heated to a temperature above the martensite start temperature (Ms) before and/or while the steel bar is bent into a ring or ring segment to make the steel bar easier to bend into shape.

FIG. 3 shows the step of heating at least part of the component to a temperature above the martensite start temperature (Ms) before the flash butt welding step. In the illustrated embodiment, heat 22 is supplied to the ends 12a, 12b of an open bearing ring that has been clamped in preparation for flash but welding.

The heat 22 may be supplied by any suitable heating means, such as by induction heating means. Additionally, or alternatively, heat 22 may be supplied using the flash butt welding apparatus itself, using alternating current (AC) for example. Once the temperature of the ends 12a, 12b or some other part of the component has reached the martensite start temperature (Ms), and preferably been held at a temperature above the martensite start temperature (Ms) for a predetermined amount of time, the ends 12a, 12b of the open bearing ring 14 can be flash butt welded together.

Alternatively, or additionally at least part of the component may be insulated before and/or during the flash butt welding step. For example, part of a component may be heated to the martensite start temperature (Ms) before the flash butt welding step while a sleeve of thermally insulating material is placed around that part and/or another part of the component. The sleeve(s) of thermally insulating material may remain in place during the flash butt welding step.

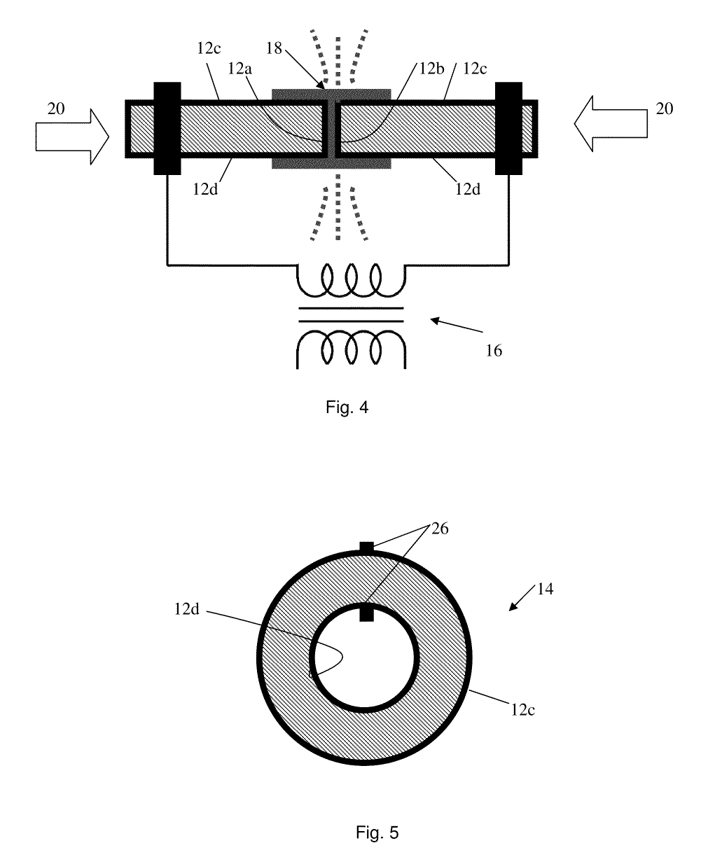

FIG. 4 shows the flash butt welding step in which the clamped ends 12a, 12b of the open bearing ring 14 are brought together at a controlled rate and current from a transformer 16 is applied. An arc is created between the two ends 12a, 12b. At the beginning of the flash butt welding process, the arc gap 18 is large enough to even out and clean the two surfaces 12a, 12b. Reducing and then closing and opening the gap 18 creates heat in the two surfaces 12a, 12b. When the temperature at the two surfaces 12a, 12b has reached the forging temperature, pressure is applied in the directions of block arrows 20 in FIG. 3 (or a moveable end is forged against a stationary end). A flash is created between the two surfaces 12a, 12b, which causes any carbon in the welding area to flow radially outwards from the surfaces 12a, 12b towards the inside and outside surfaces 12c, 12d of the bearing ring, resulting in a clean weld joint. After flashing, an upset force is suddenly applied to complete the weld. This upset force extrudes slag, oxides and molten metal from the weld zone leaving a welding accretion in the colder zone of the heated metal.

At least part of the welded component may be subjected to a post-welding heat treatment, such as carburizing, after the heat supplying step in order to increase its surface hardness, wear resistance and/or fatigue and tensile strength. Carburizing is a heat treatment process in which an iron or steel component is heated in the presence of another material that liberates carbon as it decomposes. The outer surface of the component will have a higher carbon content than the original material. When the iron or steel component is cooled rapidly by quenching, the higher carbon content on the outer surface becomes hard, while the core remains soft (i.e. ductile) and tough.

Alternatively, the welded component may be cooled after the flash butt welding step, in a water-, oil- or polymer-based quench for example.

Any welding accretion 26, containing slag, oxides and/or molten metal for example, (shown in FIG. 5) which accumulates on the inner and outer surfaces 12d and 12c of the welded bearing ring may be removed by shearing or grinding for example.

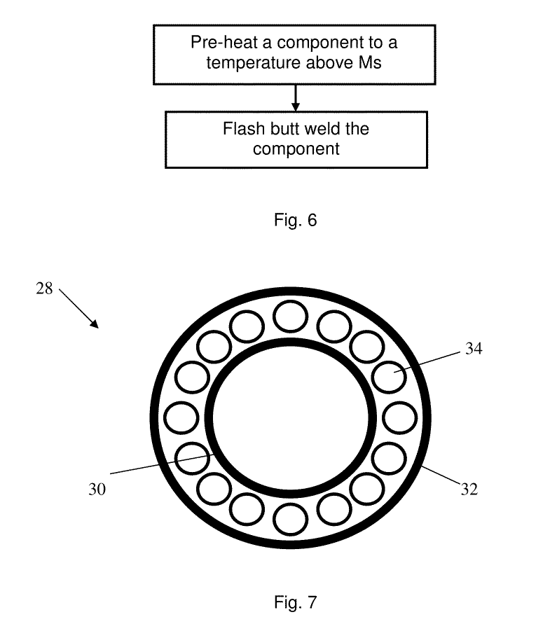

FIG. 6 shows the steps of a method for manufacturing a steel component having a flash butt weld joint according to an embodiment of the invention. The method comprises the steps of pre-heating at least part of the component to a temperature above the martensite start temperature (Ms) and then flash butt welding the component. According to an embodiment of the invention additional heat, apart from the heat generated by the flash butt welding may be supplied to at least part of the component during the flash butt welding step in order to elevate the temperature of that part of the component to the martensite start temperature (Ms) or maintain it thereat. The component is not allowed to cool substantially, or preferably not allowed to cool at all, between the pre-heating and flash butt welding steps. After the flash butt welding step, at least part of the component may be subjected to hardening heat treatment for example.

FIG. 7 shows an example of a bearing 28, namely a rolling element bearing that may range in size from 10 mm diameter to a few metres diameter and have a load-carrying capacity from a few tens of grams to many thousands of tonnes. The bearing 28 according to the present invention may namely be of any size and have any load-carrying capacity. The bearing 28 has an inner ring 30 and an outer ring 32, one or both of which may be constituted by a ring according to the present invention, and a set of rolling elements 34. The inner ring 30, the outer ring 32 and/or the rolling elements 34 of the rolling element bearing 28, and preferably all of the rolling contact parts of the rolling element bearing 28 are manufactured from steel that comprises 0.20 to 0.40 weight-% carbon.

A component manufactured using a method according to an embodiment of the invention, in which at least part of the component has been heated to a temperature above the martensite start temperature (Ms) before and/or during said flash butt welding step will have improved and/or more uniform physical properties as compared with a component manufactured using a conventional method in which a component is flash butt welded without heating at least part of the component to a temperature above the martensite start temperature (Ms) before and/or during flash butt welding.

Further modifications of the invention within the scope of the claims will be apparent to a skilled person.

1. A method for manufacturing a steel component having a flash butt weld joint, the method comprising steps of:
flash butt welding the joint, and
heating at least part of the component to a temperature above the martensite start temperature (Ms) at least one of before and during said flash butt welding step.

2. The method according to claim 1, wherein said heat is supplied by heating at least part of said component with a heating means.

3. The method according to claim 2, wherein said heating means comprises induction heating means.

4. The method according to claim 1, wherein said heat is supplied using the flash butt welding apparatus.

5. The method according to claim 4, wherein said heat is supplied using alternating current (AC).

6. The method according to claim 1, further comprising a step of cooling said component only after said flash butt welding step.

7. The method according to claim 1, further comprising a step of heating at least part of the component to a temperature of 1-50° C. above the martensite start temperature (Ms) at least one of before and during said flash butt welding step.

8. The method according to claim 1, wherein said steel has a carbon content of 0.1-1.1 weight %.

9. The method according to claim 1, wherein said component is a ring.

10. The method according to claim 11, wherein said ring is a bearing ring.

11. The method according to claim 11, wherein said ring has an outer diameter that is equal to, or greater than 0.5 m.

12. The method according to claim 9, further comprising a step of heating at least part of a steel bar to a temperature above the martensite start temperature (Ms) at least one of before and/or while the steel bar is bent into one of a ring or ring segment.

13. The method according to claim 1, wherein said steel has the following composition in weight-%:
C 0.5-1.1%
Si 0-0.15%
Mn 0-1.0%
Cr 0.01-2.0%
Mo 0.01-1.0%
Ni 0.01-2.0%
at least one of V and Nb 0.01-1.0% of V or 0.01-1.0% of Nb, or 0.01-1.0% of both elements
S 0-0.002%
P 0-0.010%
Cu 0-0.15%
Al 0.010-1.0%, and
a balance of Fe and normally occurring impurities.

14. A component having a flash butt weld joint, wherein said component is manufactured by heating at least part of the component to a temperature above the martensite start temperature (Ms) at least one of before and during said flash butt welding step.

15. The component according to claim 14, wherein said component is a ring.

16. The component according to claim 15, wherein said component is a bearing ring.
